(19) United States
(12) Patent Application Publication
(10) Pub. No.: US 2019/0053654 A1
(43) Pub. Date: Feb. 21, 2019

(54) BRACKET FOR WINDOW COVERING AND ASSEMBLY OF CASING AND BRACKET

(71) Applicant: NIEN MADE ENTERPRISE CO., LTD., Taichung (TW)

(72) Inventors: CHIH-YAO CHANG, Taichung (TW); LIN CHEN, Taichung (TW)

(21) Appl. No.: 15/679,835

(22) Filed: Aug. 17, 2017

(51) Int. Cl. A47H 1/14; E06B 9/32

(52) U.S. Cl. CPC A47H 1/14; E06B 9/50; E06B 9/32

(57) ABSTRACT

An assembly for a window covering includes a casing and a bracket. The casing includes a front wall provided with a first connecting portion, a rear wall provided with a second connecting portion, and a connecting plate, of which two sides are respectively connected to the front wall and the rear wall. The bracket includes a holding sheet and a frame, which includes a supporting plate, and has a first snap-fit portion and a second snap-fit portion respectively provided on two ends thereof, wherein the former and the latter are respectively adapted to snap-fit the first connecting portion and the second connecting portion. The holding sheet, is connected to the frame, and sequentially includes a connecting portion and a holding portion attached to the connecting portion, wherein the holding portion has an of :set relative to the connecting portion in the second direction.

### BACKGROUND OF THE INVENTION

### 1. Technical Field

The present invention relates generally to a casing and a bracket, and more particularly to a firmly installed bracket and an assembly of a casing and a bracket.

### 2. Description of Related Art

A typical window covering, e.g., a window blind or a window shade, usually has a casing fixed through a plurality of brackets to install the main structure of the window covering therein. To install such a window covering, the brackets have to be fixed on a wall, a frame, or a ceiling first, before the casing can be engaged to the brackets.

In conventional ways of installing a casing, a top of the casing has to be engaged with the brackets first before a bottom of the casing engages with the brackets. Therefore, it would be difficult to install a heavy and wide window blind merely by one man. Particularly when the top of the casing is engaged with the brackets, the casing is likely to conceal the brackets, so that the brackets would be invisible to the one who installs the casing, which increases the difficulty in aligning the casing with the brackets. This problem needs to be improved. Also, in order to provide safe and reliable window blinds to customers, the firmness and stability of the engagement between the casing and the brackets are also aspects worthy of consideration.

### BRIEF SUMMARY OF THE INVENTION

In one aspect of the invention, a bracket which could be used for convenient and firm installations is provided. An assembly of a casing and a bracket is provided as well.

In one aspect of the invention, a bracket for a window covering includes a frame and a holding sheet. A first snap-fit portion and a second snap-fit portion are respectively provided at two ends of the frame. The frame at least includes a supporting plate. The first snap-fit portion is located at a front end of the supporting plate. A direction passing through the front end and a rear end of the supporting plate is defined as a first direction, and another direction orthogonal to the first direction is defined as a second direction. The holding sheet is connected to the frame, wherein the holding sheet sequentially has a connecting portion and a holding portion attached to the connecting portion. The holding portion has an offset relative to the connecting portion in the second direction.

In one aspect of the invention, an assembly for a window covering is provided, wherein the assembly includes a casing and a bracket. The casing has a connecting plate, a front wall, and a rear wall opposite to the front wall, wherein two sides of the connecting plate are respectively connected to the front wall and the rear wall. The front wall is provided with a first connecting portion, and the rear wall is provided with a second connecting portion. A direction passing through the front wall and the rear wall is defined as a transverse direction of the casing, and the casing further has a longitudinal direction orthogonal to the transverse direction. The bracket includes a frame and a holding sheet, wherein a first snap-fit portion and a second snap-fit portion are respectively provided at two ends of the frame. The frame at least comprises a supporting plate. The first snap-fit portion is located at a front end of the supporting plate, and is adapted to snap-fit the first connecting portion; the second snap-fit portion is adapted to snap-fit the second connecting portion. The holding sheet is connected to the frame, wherein the holding sheet sequentially has a connecting portion and a holding portion attached to the connecting portion. The holding portion has an offset relative to the connecting portion in the second direction.

With the aforementioned design of the first snap-fit portion, the second snap-fit portion, and the holding sheet of the bracket, the casing could be firmly engaged with the bracket, and would not be easily moved relative to each other.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of the assembly of the casing and the bracket of a first embodiment of the present invention;

FIG. 2A is a perspective view of the bracket of the first embodiment;

FIG. 2B is a sectional view along the 2B-2B line in FIG. 2A;

FIG. 2C is a bottom view of the bracket of the first embodiment;

FIGS. 3A and 3B are schematic views showing the installation of the bracket and the casing of the first embodiment;

FIG. 4A is a lateral view of the assembly of the casing and the bracket of a second embodiment of the present invention;

FIG. 4B is a top view of the assembly of the casing and the bracket of the second embodiment;

FIG. 4C is a bottom view of the bracket of the second embodiment;

FIG. 4D is a bottom view of the bracket of another embodiment; FIG. 5A is a lateral view of the assembly of the casing and the bracket of a third embodiment of the present invention;

FIG. 5B is a perspective view of the assembly of the casing and the bracket of the third embodiment;

FIG. 5C is a bottom view of the bracket of the third embodiment;

FIG. 6A is a perspective view of the assembly of the casing and the bracket of a fourth embodiment of the present invention;

FIG. 6B is a lateral view of the assembly of the casing and the bracket of the fourth embodiment;

FIG. 6C is a bottom view of the assembly of the casing and the bracket of the fourth embodiment; and

FIG. 6D is a sectional view along the 6D-6D line in FIG. 6A.

### DETAILED DESCRIPTION OF THE INVENTION

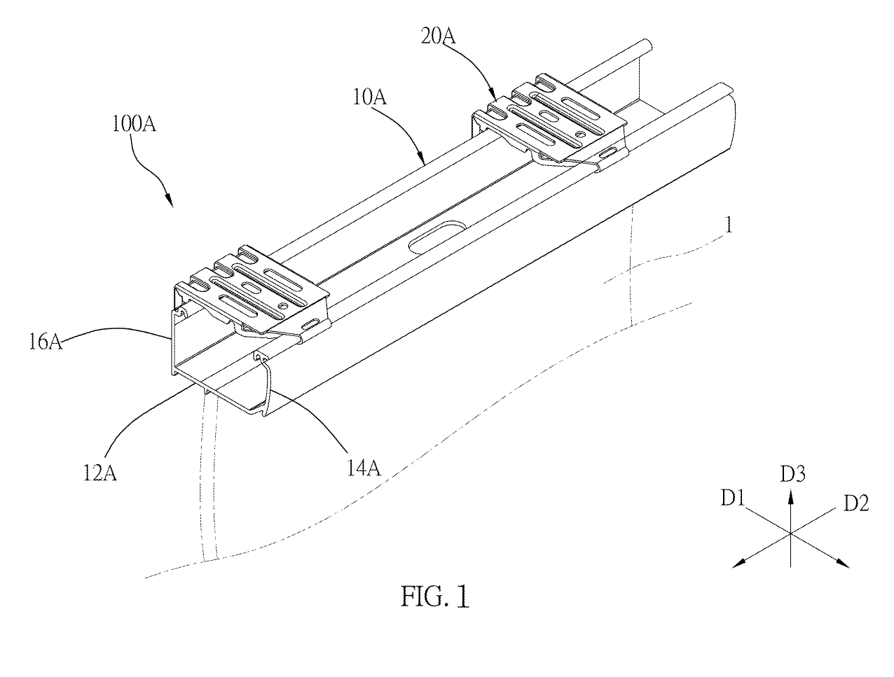

An assembly 100A of a casing and a bracket of a first embodiment of the present invention is illustrated in FIG. 1, which is adapted to be installed at a predetermined position (not shown), wherein the predetermined position includes, but not limited to, a location on a wall, a frame, and a ceiling. The assembly 100A includes a casing 10A and at least one bracket 20A. In the current embodiment, the bracket 20A includes two brackets 20A. The brackets 20A are firmly provided at the predetermined position. The casing 10A is held and positioned by the brackets 20A, and is adapted to be provided with a curtain 1.

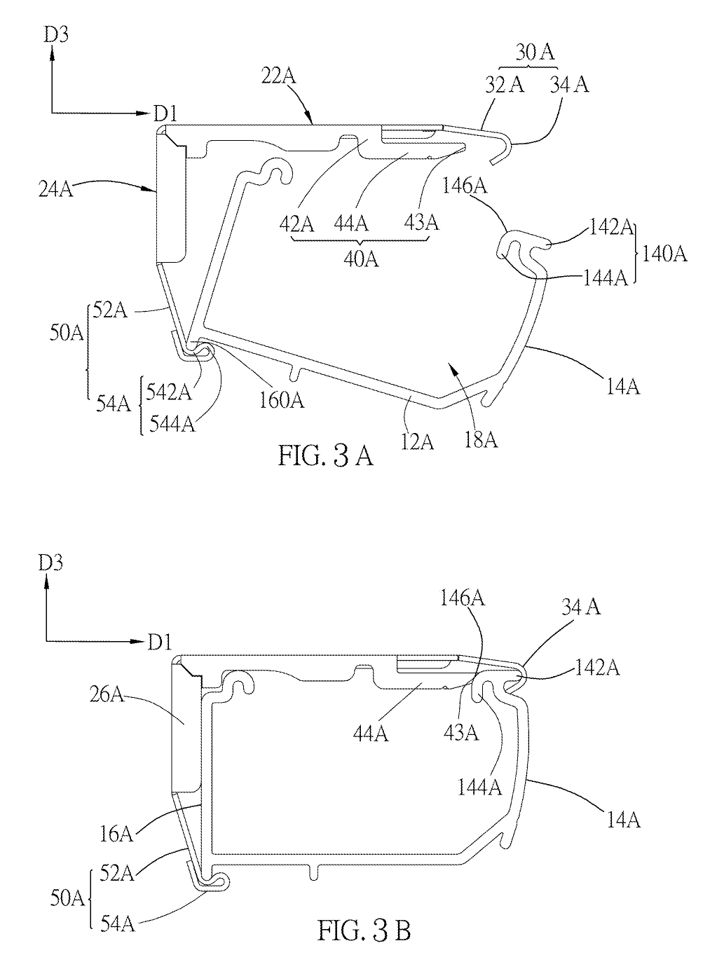

As shown in FIG. 1, FIG. 3A, and FIG. 3B, the casing 10A is long in shape, including a connecting plate 12A, a front wall 14A, a rear wall 16A opposite to the front wall 14A, and a receiving chamber 18A surrounded by the connecting plate 12A, the front wall 14A, and the rear wall 16A. The receiving chamber 18A is adapted to accommodate window covering components; said window covering components may include, but not limited to, pulleys and guide rods. A first connecting portion 140A is provided on a top of the front wall 14A. In the current embodiment, the first connecting portion 140A includes an outer lip 142A extending forward and an inner lip 144A extending inward and downward, wherein an bulging surface 146A is provided on the inner lip 144A. A second connecting portion 160A is provided on a bottom of the rear wall 16A. In addition, the casing 10A can be defined to have a transverse direction, i.e., the direction passing through the front wall 14A and the rear wall 16A, and a longitudinal direction orthogonal to the transverse direction.

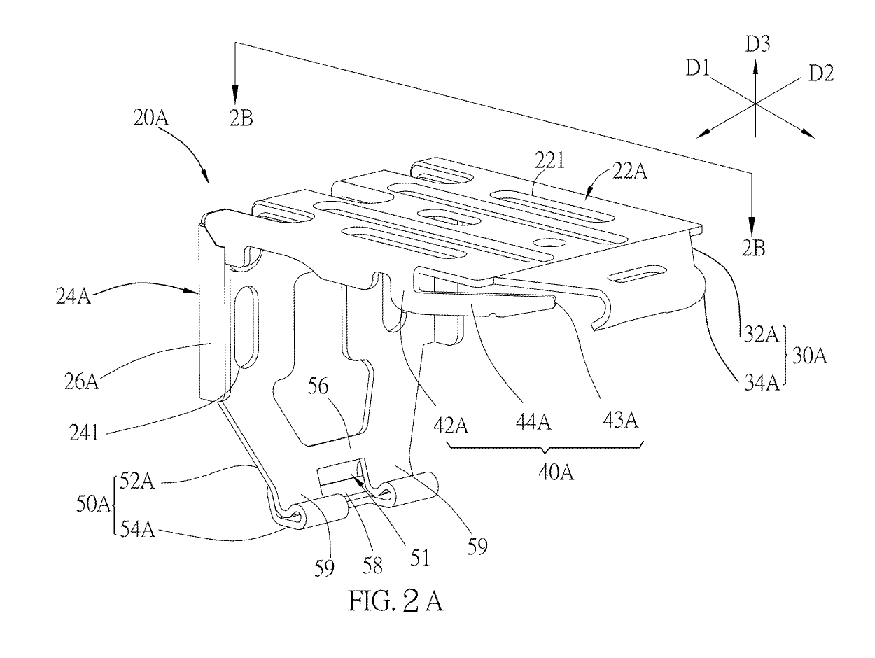

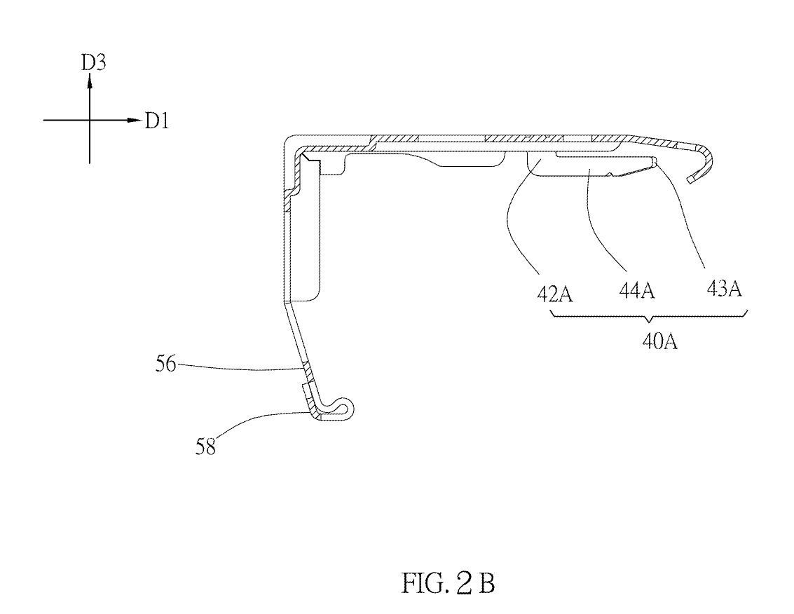

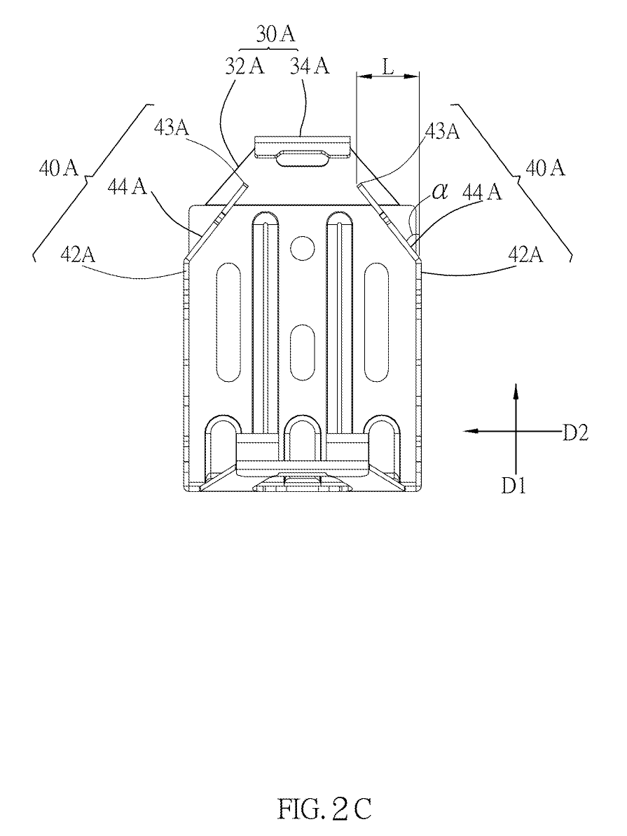

As shown in FIG. 2A, FIG. 2B and FIG. 2C, the bracket 20A includes a frame and a holding sheet 40A. In the current embodiment, the frame includes a supporting plate 22A and a rear plate 24A which are connected to each other. A first snap-fit portion 30A is provided at a front end of the supporting plate 22A, wherein the first snap-fit portion 30A is adapted to snap-fit the outer lip 142A of the front wall 14A of the casing 10A. The supporting plate 22A has the holding sheet 40A adapted to push against the bulging surface 146A of the front wall 14A of the casing 10A. In the current embodiment, the supporting plate 22A has a plurality of positioning holes 221, which are adapted to be passed through by fasteners such as screws to get fixed onto the predetermined position. The first snap-fit portion 30A includes a extension portion 32A and a hook portion 34A which are connected to each other, wherein the extension portion 32A extends forward from the front end of the supporting plate 22A, and the extension portion 32A, referred in the current embodiment, gradually tappers from a rear end to the front end of the supporting plate 22A. The extension portion 32A, referred in the current embodiment, could also slightly tilt downward. The hook portion 34A is bent or curved inward from the extension portion 32A and/or further extends downward, and is adapted to snap-fit the outer lip 142A of the front wall 14A of the casing 10A.

In the current embodiment, an angle a, which is included between an extension line of a projection of the holding sheet 40A orthogonally projected on the supporting plate 22A and an extension line connecting the front end and the rear end of the supporting plate 22A, is greater than 0 degree and less than or equal to 45 degrees. In other words, if a direction passing through the front end and the rear end of the supporting plate 22A is defined as a first direction D1, and another direction orthogonal to the first direction D1 is defined as a second direction D2, the holding sheet 40A has a first portion, and a second portion other than the first portion, wherein the second portion has an offset relative to the first portion in the second direction. Since the angle a is greater than 0 degree, the offset of the second portion exists thereby. In the current embodiment, an extension plain of a top surface of the supporting plate 22A is defined as a horizontal plain, wherein the second direction D2 is parallel to the horizontal plain. In the current embodiment, an imaginary plain can be defined through the first direction D1 and the second direction D2, wherein the top surface of the supporting plate 22A, i.e., the horizontal plain, is parallel to the imaginary plain. The first direction D1 and the second direction D2 are both orthogonal to a third direction D3, which is vertical to the imaginary plain. In more details, the number of the holding sheets 40A is two. Furthermore, the two holding sheets 40A, referred in the current embodiment, are provided corresponding to each other and may be additionally arranged in symmetry. Each of the holding sheets 40A includes a connecting portion 42A and a holding portion 44A attached to the connecting portion 42A, wherein the connecting portion 42A extends downward from a lateral edge of the supporting plate 22A, and the holding portion 44A extends toward the first snap-fit portion 30A from the connecting portion 42A. The holding portions 44A of the two holding sheets 40A are substantially in parallel to the supporting plate 22A in the current embodiment; however, this is not a limitation of the present invention. Furthermore, the holding portions 44A are adapted to push against an inner surface of the front wall 14A. As shown in FIG. 2C, each of the holding portion 44A has an offset relative to the corresponding connecting portion 42A in the second direction D2.

In addition, in the current embodiment, each of the holding portions 44A has a holding end 43A at an end thereof away from the respective one of the connecting portions 42A, wherein each of the holding ends 43A is adapted to abut against the inner surface of the front wall 14A, and a distance between the holding ends 43A is less than a distance between the connecting portions 42A, which means, in the current embodiment, a distance between the holding portions 44A gradually reduces from the rear end toward the front end of the supporting plate 22A. Whereby, the holding end 43A of each of the holding portion 44A has an offset L relative to the corresponding connecting portion 42A in the second direction D2. When the holding ends 43A of the holding sheets 40A abut against an inner surface of the front wall 14A of the casing 10A, the aforementioned design (i.e., the holding portions 44A gradually approach each other) would help to offset a relative movement possibly created between the casing 10A and each of the brackets 20A due to a force somehow occurred in the longitudinal direction of the casing 10A(i.e., the second direction D2 of the holding sheet 40A), whereby to prevent the casing 10A and the brackets 20A from being slid or moved relative to each other in the longitudinal direction of the casing 10A. In more details, when the casing 10A and the brackets 20A are about to be moved relative to each other due to the force, at least one of the holding ends 43A of the corresponding holding sheet 40A, abutting against the inner surface of the front wall 14A of the casing 10A, is capable of resisting against the front wall 14A of the casing 10A, and offsetting and counterbalancing the force thereby to prevent the relative movement. It is also worth mentioning that, though the distance between the holding portions 44A reduces in the current embodiment, and the holding ends 43A of each of the holding portion 44A has the offset L relative to the corresponding connecting portion 42A in the second direction D2, this is not a limitation of the present invention. In other embodiments, the distance between the holding portions 44A could increase instead. The effect of counterbalancing the force in the longitudinal direction of the casing 10A (i.e., the second direction D2 of the holding sheet 40A) would still be achievable.

The rear plate 24A extends downward from the rear end of the supporting plate 22A, wherein a second snap-fit portion 50A is provided on a bottom of the rear plate 24A. The second snap-fit portion 50A is adapted to snap-fit a bottom of the rear wall 16A of the casing 10A. In addition, on at least one of two lateral sides of the rear plate 24A, a wing is provided to extend toward the first snap-fit portion 30A. In the current embodiment, two wings 26A extending forward are provided respectively on two lateral sides of the rear plate 24A. The wings 26A are adapted to abut against an outer surface of the rear wall 16A of the casing 10A. Also, in the current embodiment, the second snap-fit portion 50A extends toward the first snap-fit portion 30A from a bottom end of the rear plate 24A, wherein the second snap-fit portion 50A includes an engaging plate 52A extending downward and forward from the bottom end of the rear plate 24A. Furthermore, a supporting portion 54A is disposed on the engaging plate 52A. The supporting portion 54A includes a base portion 542A, which is connected to the engaging plate 52A and adapted to uphold the bottom end of the rear wall 16A, and a limit portion 544A, which is attached to a front edge of the engaging plate 52A and adapted to keep the bottom end of the rear wall 16A from slipping outward. In the current embodiment, the supporting portion 54A is formed by extending forward from the engaging plate 52A and being bent slightly upward, whereby the base portion 542A and the limit portion 544A are formed consequently. However, the method of forming the supporting portion 54A is not a limitation of the present invention. The supporting portion 54A of another embodiment could be further made by being folded backward after being bent slightly upward. The supporting portion 54A is adapted to snap-fit the bottom end of the rear wall 16A, and has the advantage of providing superior strength to firmly hold the casing 10A, for the supporting portion 54A is formed by folding the engaging plate 52A. Also, the rear plate 24A includes a plurality of positioning holes 241, which are adapted to be passed through by fasteners such as screws to get fixed. As shown in FIG. 2A and FIG. 2B, an opening 51 is provided at a remote end of the second snap-fit portion 50A, wherein the opening 51 is close to the second connecting portion 160A of the casing 10A. More specifically, the second snap-fit portion 50A has an upper horizontal segment 56, a lower horizontal segment 58, and two vertical segments 59 provided at the remote end of the second snap-fit portion 50A, wherein the opening 51 is at least defined by the upper horizontal segment 56, one of the two vertical segments 59 and the lower horizontal segment 58. In the current embodiment, the opening 51 is defined by the upper horizontal segment 56, the lower horizontal segment 58, and the vertical segments 59 together; wherein the lower horizontal segment 58 is closer to the rear side than the upper horizontal segment 56 is.

As shown in FIG. 3A and FIG. 3B, to complete the installation, the brackets 20A could be fixed at predetermined positions first, and then the casing 10A and the brackets 20A could be engaged together. In more details, upon installation, the casing 10A could be tilted slightly forward to make the second connecting portion 160A of the rear wall 16A of the casing 10A abut against the supporting portion 54A of the second snap-fit portion 50A of each of the brackets 20A. Whereby, the brackets 20A could be effectively utilized to bear the weight of the casing 10A. After that, the casing 10A could be rotated and pushed backward with the second snap-fit portion 50A used as a fulcrum, so as to press the rear wall 16A of the casing 10A against the rear plate 24A of each of the brackets 20A, and to push the first connecting portion 140A of the casing 10A into the first snap-fit portion 30A of each of the brackets 20A. As a result, for each of the brackets 20A, the first snap-fit portion 30A thereof would snap-fit the outer side of the first connecting portion 140A, and the holding sheets 40A thereof would push against the inner side of the first connecting portion 140A. More specifically, for each of the brackets 20A, the hook portion 34A of the first snap-fit portion 30A would hook onto the outer lip 142A, while the holding portions 44A of the holding sheets 40A could push against the bulging surface 146A on the inner side of the inner lip 144A.

On the contrary, reversely performing the aforementioned installation steps could detach the casing 10A from the brackets 20A. In other words, the first connecting portion 140A of the casing 10A should be released from the first snap-fit portions 30A of the brackets 20A first. At this time, most of the weight of the casing 10A would be supported by the second snap-fit portions 50A of the brackets 20A, and therefore the casing 10A would be less cumbersome to hold. And then, the whole casing 10A could be removed from the second snap-fit portions 50A, so as to be completely disengaged. Alternatively, a tool with a flattened head (e.g., a standard screwdriver) could also be used to disengage the casing 10A from the brackets 20A. In more details, a head of a standard screwdriver could be inserted into the second snap-fit portion 50A of one of the brackets 20A, passing through the lower horizontal segment 58, the opening 51, and the upper horizontal segment 56 at the remote end of the second snap-fit portion 50A sequentially. By leveraging the standard screwdriver, the second snap-fit portion 50A of the current bracket 20A and the second connecting portion 160A of the casing 10A could be disengaged. After that, the removal of the casing 10A could be completed by disengaging the first connecting portion 140A of the casing 10A from the first snap-fit portions 30A of the brackets 20A.

Whereby, with the aforementioned design of the second snap-fit portion 50A of the bracket 20A, most of the weight of the casing 10A could get supported during installation, which would make the process less cumbersome, and therefore would facilitate the subsequent steps. In addition, with the aforementioned design of the first snap-fit portion 30A and the holding sheet 40A of each of the brackets 20A, the inner and outer sides of the rear wall 14A could be effectively held, whereby the casing 10A and the brackets 20A would be unlikely to have relative sliding movement after being assembled. Therefore, the assembly would be firmly set up. Furthermore, with the design that the engaging plate 52A of the second snap-fit portion 50A extends slightly forward, and the design that the extension portion 32A of the first snap-fit portion 30A extends slightly downward, a preload force could be effective exerted on both the rear wall 16A and the front wall 14A of the casing 10A. Also, each of the wings 26A could, with its design, firmly push against and hold the casing 10A by abutting against the surface of the rear wall 16A of the casing 10A. In addition, the first snap-fit portion 30A and the second snap-fit portion 50A of each of the brackets 20A which are adapted to snap-fit the casing 10A are both exposed. Therefore, during installation, the relative positions between these snap-fitting positions of each of the brackets 20A and the casing 10A could be easily seen, which would be helpful for facilitating the alignment and installation.

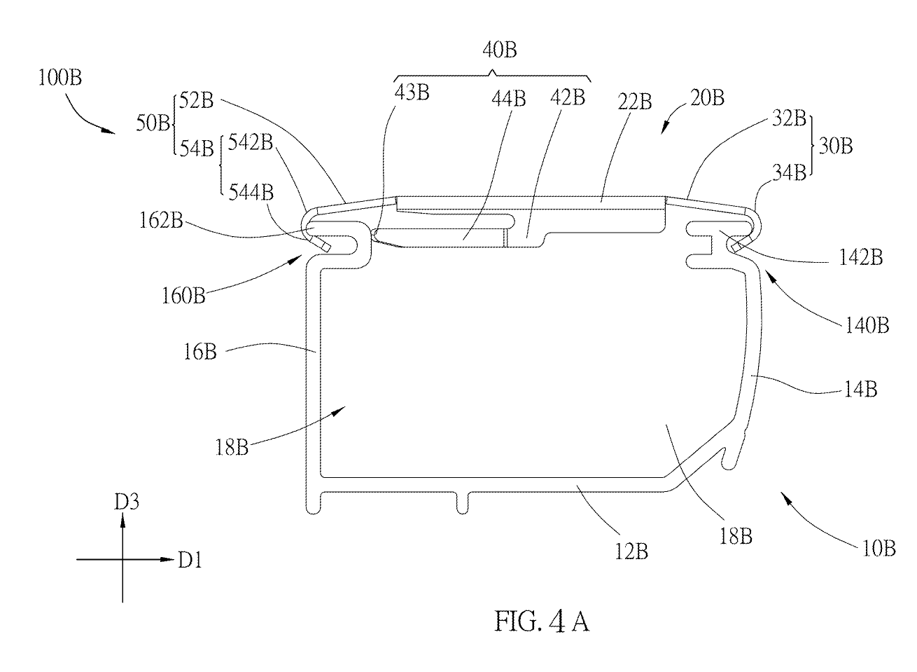

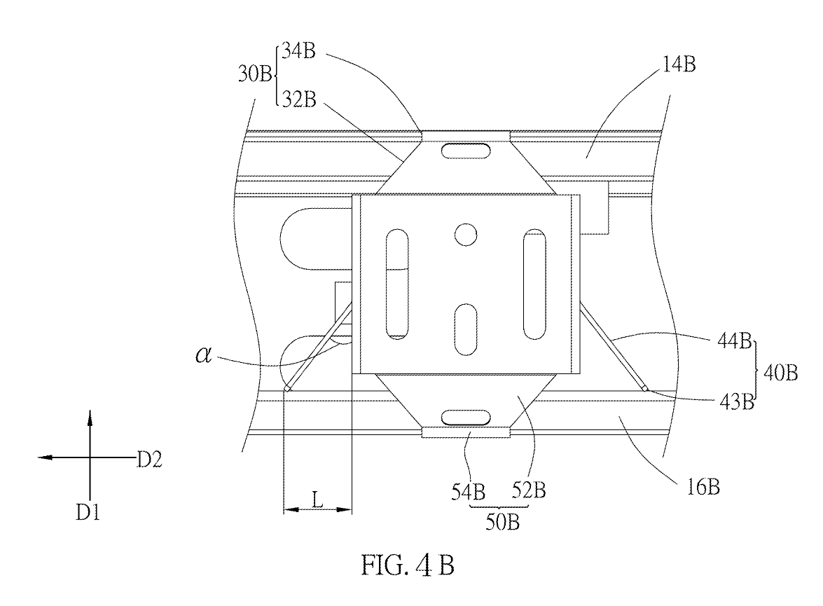

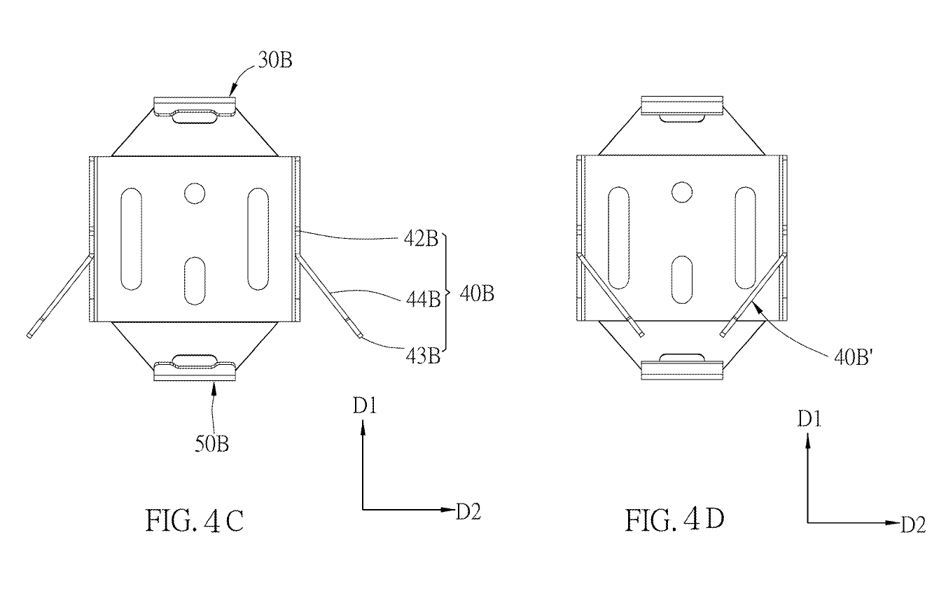

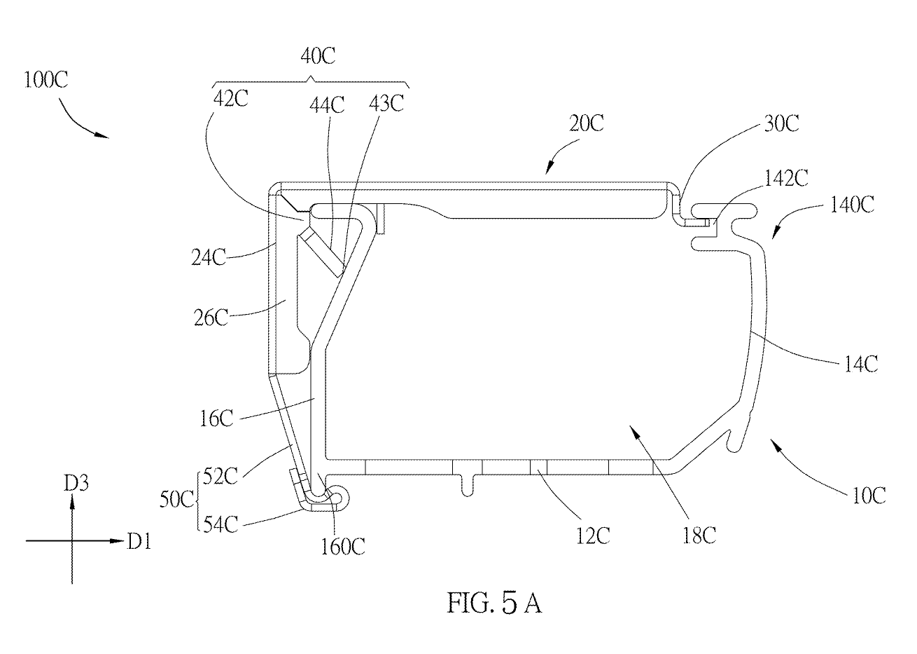

An assembly 100B of a casing and a bracket of a second embodiment of the present invention is illustrated in FIG. 4A, FIG. 4B, and FIG. 4C, which is adapted to be installed at a predetermined position (not shown), wherein the predetermined position includes, but not limited to, a location on a wall, a frame, and a ceiling. The assembly 100B includes a casing 10B and at least one bracket 20B. In the current embodiment, the casing 10B is long in shape, and includes a connecting plate 12B, a front wall 14B, a rear wall 16B opposite to the front wall 14B, and a receiving chamber 18B defined by the connecting plate 12B, the front wall 14B, and the rear wall 16B. The receiving chamber 18B is adapted to accommodate window covering components. Said window covering components may include, but not limited to, pulleys and guide rods. A first connecting portion 140B is provided on a top of the front wall 14B. In the current embodiment, the first connecting portion 140B includes an outer lip 142B extending forward. A second connecting portion 160B is provided on a top of the rear wall 16B, wherein the second connecting portion 160B includes an outer lip 162B extending backward. In addition, the casing 10B is defined to have a transverse direction, which is the direction passing through the front wall 14B and the rear wall 16B, and a longitudinal direction, which is orthogonal to the transverse direction.

In the current embodiment, the bracket 20B includes a supporting plate 22B and a holding sheet 40B which are connected to each other. A first snap-fit portion 30B is provided at a front end of the supporting plate 22B, wherein the first snap-fit portion 30B is adapted to snap-fit the outer lip 142B of the front wall 14B of the casing 10B. A second snap-fit portion 50B is provided at a rear end of the supporting plate 22B, wherein the second snap-fit portion 50B is adapted to snap-fit the outer lip 162B of the rear wall 16B of the casing 10B. In the current embodiment, the first snap-fit portion 30B includes a extension portion 32B and a hook portion 34B which are connected to each other, wherein the extension portion 32B extends toward from the front end of the supporting plate 22B, and the extension portion 32B, referred in the current embodiment, gradually tappers from a rear end to the front end of the supporting plate 22B. Furthermore, the extension portion 32B, referred in the current embodiment, could also slightly tilt downward. The hook portion 34B is bent or curved inward from the extension portion 32B and/or further extends downward, and is adapted to snap-fit the outer lip 142B of the front wall 14B of the casing 10B. The second snap-fit portion 50B and the first snap-fit portion 30B have approximately the same outlines, but are in opposite directions. The second snap-fit portion 50B includes a extension portion 52B and a hook portion 54B which are connected to each other, wherein the extension portion 52B extends backward from the rear end of the supporting plate 22B, and the extension portion 52B gradually tappers from the front end to the rear end of the supporting plate 22B. Furthermore, the extension portion 52B could also slightly tilt downward. The hook portion 54B is bent or curved downward and inward from the extension portion 52B, and is adapted to snap-fit the outer lip 162B of the rear wall 16B of the casing 10B. In the current embodiment, the extension portion 52B of the second snap-fit portion 50B works as the engaging plate 52A of the second snap-fit portion 50A in the first embodiment, while the hook portion 54B of the second snap-fit portion 50B works as the supporting portion 54A of the second snap-fit portion 50A in the first embodiment. The hook portion 54B is also provided with a base portion 542B, which is connected to the extension portion 52B and adapted to hold a top end of the rear wall 16B, and further includes a limit portion 544B, which is attached to the base portion 542B and adapted to keep the top end of the rear wall 16B from slipping.

The holding sheet 40B is adapted to push against an inner surface of the rear wall 16B of the casing 10B. In the current embodiment, an end of the holding sheet 40B is connected to the supporting plate 22B. Furthermore, in the current embodiment, an angle a, which is included between an extension line of a projection of the holding sheet 40B orthogonally projected on the supporting plate 22B and an extension line connecting the front end and the rear end of the supporting plate 22B, is greater than 0 degree and less than or equal to 45 degrees. In other words, if the direction passing through the front end and the rear end of the supporting plate 22B is defined as a first direction D1, and the direction orthogonal to the first direction D1 is defined as a second direction D2, the holding sheet 40B has a first portion, and a second portion other than the first portion, wherein the second portion has an offset relative to the first portion in the second direction D2. In the current embodiment, an extension plain of a top surface of the supporting plate 22B is defined as a horizontal plain, wherein the second direction D2 is parallel to the horizontal plain. In the current embodiment, an imaginary plain can be defined through the first direction D1 and the second direction D2, wherein the top surface of the supporting plate 22B is parallel to the imaginary plain. The first direction D1 and the second direction D2 are both orthogonal to a third direction D3, which is vertical to the imaginary plain. In more details, the number of the holding sheets 40B is two. Furthermore, the holding sheets 40B are provided corresponding to each other in symmetry. Each of the holding sheets 40B includes a connecting portion 42B and a holding portion 44B, wherein the connecting portion 42B extends downward from a lateral edge of the supporting plate 22B, and the holding portion 44B extends toward the second snap-fit portion 50B from the connecting portion 42B. The holding portions 44B of the two holding sheets 40B are substantially in parallel to the supporting plate 22B in the current embodiment. However, this is not a limitation of the present invention. Furthermore, the holding portions 44B are adapted to push against an inner surface of the rear wall 16B. As shown in FIG. 4B, each of the holding portion 44B has an offset relative to the corresponding connecting portion 42B in the second direction D2.

In addition, in the current embodiment, each of the holding portions 44B has a holding end 43B at an end thereof away from the corresponding connecting portion 42B, wherein each of the holding end 43B is adapted to abut against the inner surface of the rear wall 16B, and a distance between the holding ends 43B is less than a distance between the connecting portions 42B, which means, in the current embodiment, a distance between the holding portions 44B gradually increases from the front end toward the rear end of the supporting plate 22B. When the holding ends 43B of the holding sheets 40B abut against the inner surface of the rear wall 16B of the casing 10B, the aforementioned design (i.e., the holding portions 44B gradually extend outward) would help to offset the a relative movement possibly created between the casing 10B and each of the brackets 20B due to a force somehow occurred in the longitudinal direction of the casing 10B (i.e., the second direction D2 of the holding sheet 40B), whereby to prevent the casing 10B and the brackets 20B from being slid or moved relative to each other in the longitudinal direction of the casing 10B. In more details, when the casing 10B and the brackets 20B are about to be moved relative to each other due to the force, at least one of the holding ends 43B of the corresponding holding sheet 40B, abutting against the inner surface of the front wall 14B of the casing 10B, is capable of resisting against the front wall 14B of the casing 10B, and offsetting and counterbalancing the force thereby to prevent the relative movement. It is also worth mentioning that, though the distance between the holding portions 44B increases in the current embodiment, and the holding ends 43B of each of the holding portion 44B has an offset L relative to the corresponding connecting portion 42B in the second direction D2, this is not a limitation of the present invention. In other embodiments referred in FIG. 4D, the distance between holding portions 443 could decrease instead. The effect of offsetting the force in the longitudinal direction of the casing 10B would still be achievable.

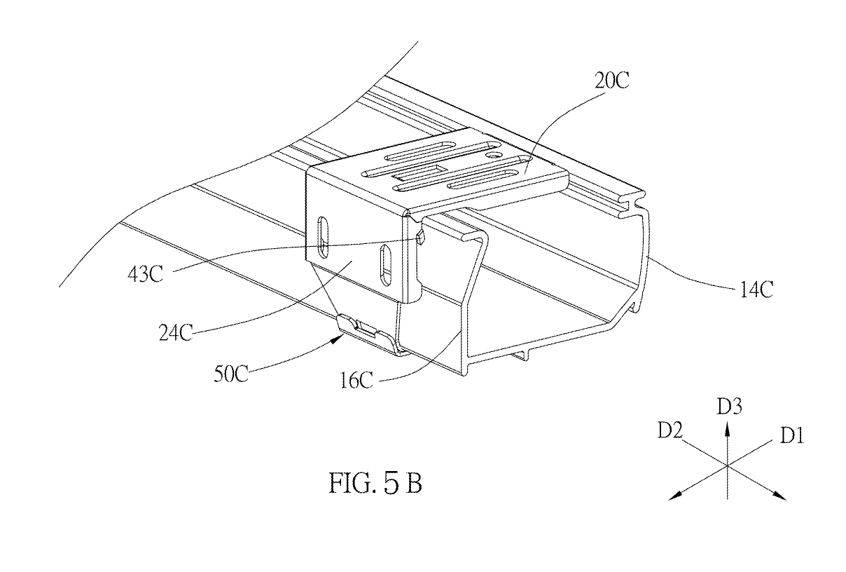

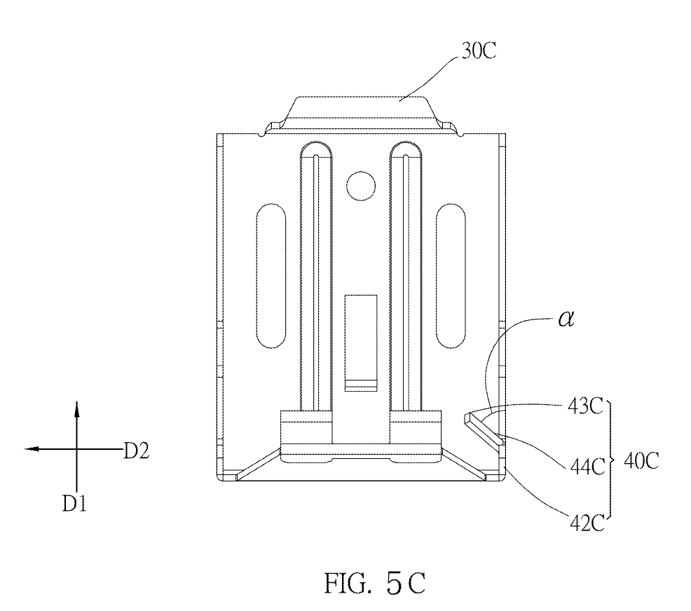

An assembly 100C of a casing and a bracket of a third embodiment of the present invention is illustrated in FIG. 5A, FIG. 5B, and FIG. 5C, which is adapted to be installed at a predetermined position (not shown), wherein the predetermined position includes, but not limited to, a location on a wall, a frame, and a ceiling. The assembly 100C includes a casing 10C and at least one bracket 20C. In the current embodiment, the casing 10C is long in shape, and includes a connecting plate 12C, a front wall 14C, a rear wall 16C opposite to the front wall 14C, and a receiving chamber 18C defined by the connecting plate 12C, the front wall 14C, and the rear wall 16C. The receiving chamber 18C is adapted to accommodate window covering components. Said window covering components may include, but not limited to, pulleys and guide rods. A first connecting portion 140C is provided on a top of the front wall 14C. In the current embodiment, the first connecting portion 140C includes a recess portion 142C, of which an opening communicating with the receiving chamber 18C. A second connecting portion 160C is provided on a bottom end of the rear wall 16C.

In the current embodiment, the bracket 20C includes a frame and a holding sheet 40C, wherein the frame includes a supporting plate 22C and a rear plate 24C which are connected to each other. A first snap-fit portion 30C is provided at a front end of the supporting plate 22C, wherein the first snap-fit portion 30C is adapted to snap-fit the recess portion 142C of the front wall 14C of the casing 10C. The holding sheet 40C is adapted to push against an outer surface (i.e., rear surface) of the rear wall 16C of the casing 10C. In more details, an end of the holding sheet 40C is connected to the rear plate 24C. Furthermore, in the current embodiment, an angle a, which is included between an extension line of a projection of the holding sheet 40C orthogonally projected on the supporting plate 22C and an extension line connecting the front end and the rear end of the supporting plate 22C, is greater than 0 degree and less than or equal to 45 degrees. In other words, if a direction passing through the front end and the rear end of the supporting plate 22C is defined as a first direction D1, and another direction orthogonal to the first direction D1 is defined as a second direction D2, the holding sheet 40C has a first portion, and a second portion other than the first portion, wherein the second portion has an offset relative to the first portion in the second direction D2. In the current embodiment, an extension plain of a top surface of the supporting plate 22C is defined as a horizontal plain, wherein the second direction D2 is parallel to the horizontal plain. In the current embodiment, an imaginary plain can be defined through the first direction D1 and the second direction D2, wherein the top surface of the supporting plate 22C is parallel to the imaginary plain. The first direction D1 and the second direction D2 are both orthogonal to a third direction D3, which is vertical to the imaginary plain. In the current embodiment, the number of the holding sheet 40C is one, and the holding sheet 40C is provided at a lateral edge of the rear plate 24C. The holding sheet 40C includes a connecting portion 42C and a holding portion 44C, wherein the connecting portion 42C extends forward from the lateral edge of the rear plate 24C, and the holding portion 44C extends downward and forward from an end of the connecting portion 42C away from the rear plate 24C, so that a holding end 43C of the holding portion 44C would push against the outer surface of the rear wall 16C. Limiting the design range of the angle a included between the two aforementioned extension lines (i.e., the extension line of the projection of the holding sheet 40C orthogonally projected on the supporting plate 22C and the extension line connecting the front end and the rear end of the supporting plate 22C) would help to offset the a relative movement possibly created between the casing 10C and each of the brackets 20C due to a force somehow occurred in the longitudinal direction of the casing 10C (i.e., the second direction D2 of the holding sheet 40C). When the holding end 43C of the holding sheet 40C abuts against the outer surface of the rear wall 16C of the casing 10C, the casing 10C and the brackets 20C could be prevented from being slid or moved relative to each other in the longitudinal direction of the casing 10C. In more details, when the casing 10C and the brackets 20C are about to be moved relative to each other due to the force occurred in the longitudinal direction of the casing 10C, the holding end 43C of the holding sheet 40C would firmly abut against the outer surface of the rear wall 16C of the casing 10C in the longitudinal direction of the casing 10C, whereby to create a strong reverse resistance to the outer surface of the rear wall 16C of the casing 10C. As a result, the casing 10C and the brackets 20C could be prevented from being moved relative to each other in the longitudinal direction of the casing 10C.

The rear plate 24C extends downward from the rear end of the supporting plate 22C. A second snap-fit portion 50C is provided at a bottom end of the rear plate 24C, wherein the second snap-fit portion 50C is adapted to snap-fit the bottom end of the rear wall 16C of the casing 10C. In the current embodiment, a wing 26C extending forward is respectively provided on each of two sides of the rear plate 24C, wherein the wings 26C are adapted to abut against the outer surface of the rear wall 16C of the casing 10C. In the current embodiment, the holding sheet 40C extends forward from one of the wings 26C. However, this is not a limitation of the present invention. In other embodiments, the holding sheet 40C could also extend forward from any position on the rear plate 24C, as long as the holding end 43C of the holding portion 44C could push against the outer surface of the rear wall 16C. Also, in the current embodiment, the second snap-fit portion 50C includes an engaging plate 52C extending downward and forward from the bottom end of the rear plate 24C. Furthermore, a supporting portion 54C is disposed on the engaging plate 52C. The supporting portion 54C is adapted to snap-fit the bottom end of the rear wall 16C, and has the advantage of providing superior strength to firmly hold the casing 10C, for the supporting portion 54C is formed by folding the engaging plate 52C. The second snap-fit portion 50C of the current embodiment is similar to the second snap-fit portion 50A of the first embodiment of the present invention, and therefore, herein we are not going to describe the structures of the second snap-fit portion 50C and the details about how the second snap-fit portion 50C could be utilized to conveniently install and remove the casing 10C.

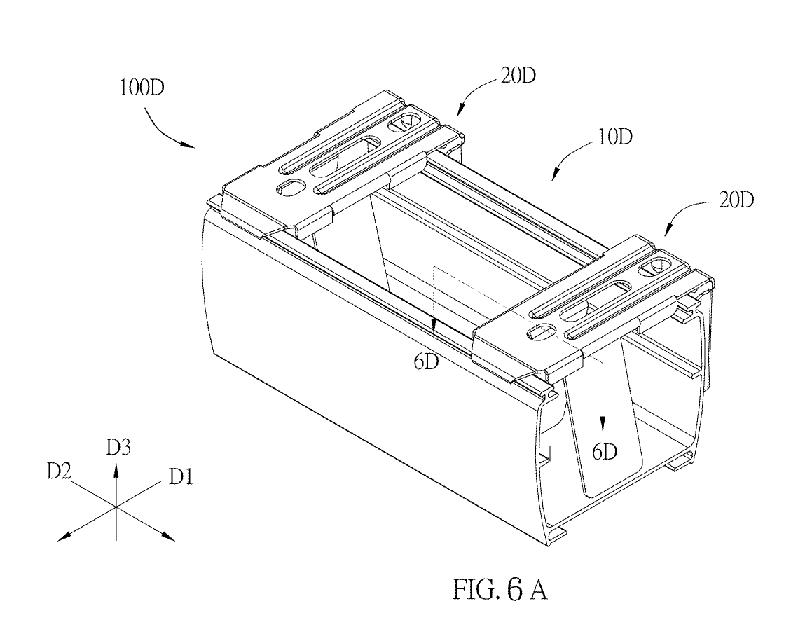

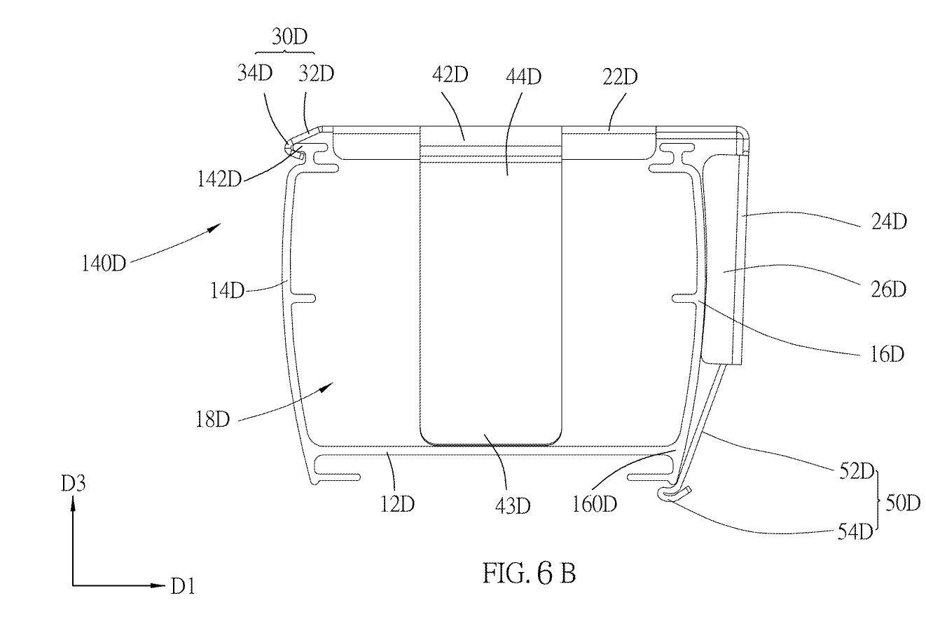

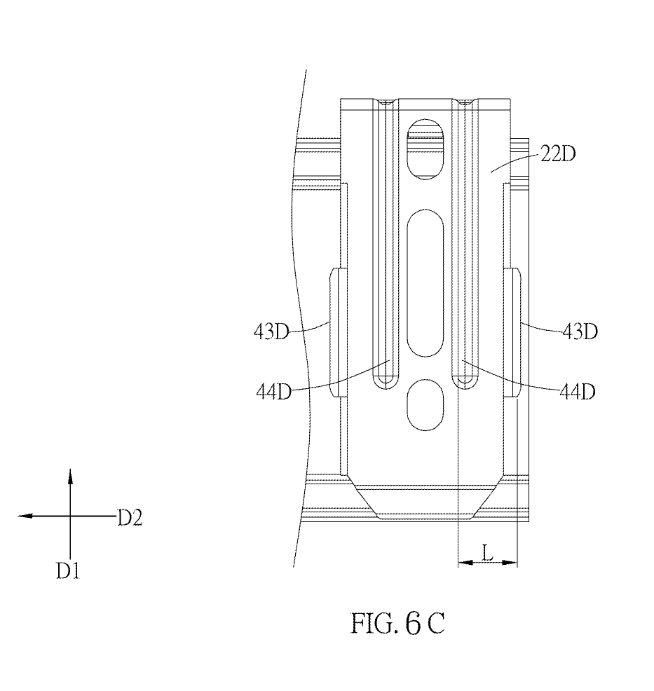

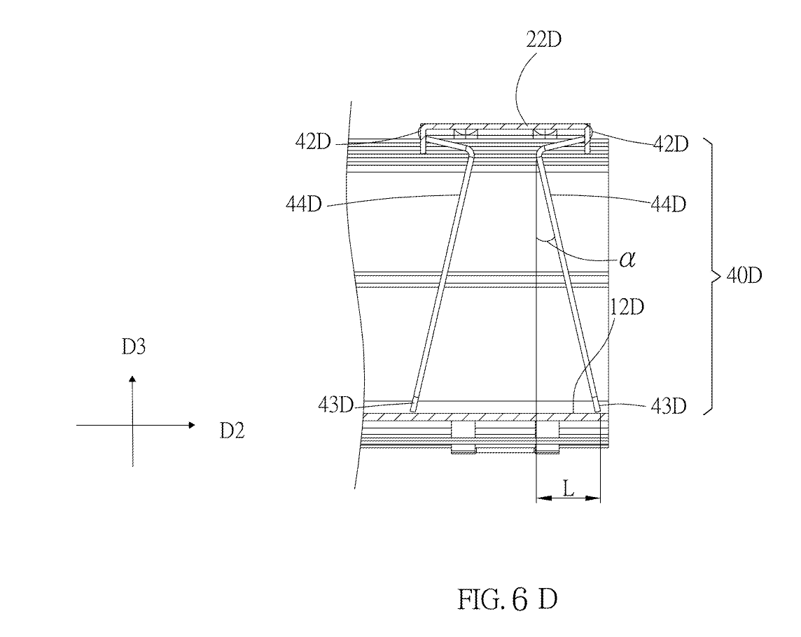

An assembly 100D of a casing and a bracket of a fourth embodiment of the present invention is illustrated in FIG. 6A to FIG. 6D, which is adapted to be installed at a predetermined position (not shown), wherein the predetermined position includes, but not limited to, a location on a wall, a frame, and a ceiling. The assembly includes a casing 10D and at least one bracket 20D. In the current embodiment, the casing 10D is long in shape, and includes a connecting plate 12D, a front wall 14D, rear wall 16D opposite to the front wall 14D, and a receiving chamber 18D defined by the connecting plate 12D, the front wall 14D, and the rear wall 16D. The receiving chamber 18D is adapted to accommodate window covering components. Said window covering components may include, but not limited to, pulleys and guide rods. A first connecting portion 140D is provided on a top of the front wall 14D. In the current embodiment, the first connecting portion 140D includes an outer lip 142D extending forward. A second connecting portion 160D is proved on a bottom of the rear wall 16D. In addition, the casing 10D can be defined to have a transverse direction i.e., the direction passing through the front wall 14D and the rear wall 16D, and a longitudinal direction orthogonal to the transverse direction.

In the current embodiment, the bracket 20D includes a frame and a holding sheet 40D, wherein the frame includes a supporting plate 22D and a rear plate 24D which are connected to each other. A first snap-fit portion 30D is provided at a front end of the supporting plate 22D, wherein the first snap-fit portion 30D is adapted to snap-fit the outer lip 142D of the front wall 14D of the casing 10D. In the current embodiment, the first snap-fit portion 30D includes a extension portion 32D and a hook portion 34D which are connected to each other, wherein the extension portion 32D extends forward from the front end of the supporting plate 22D, and the extension portion 32D gradually tappers from a rear end to the front end of the supporting plate 22D. Furthermore, the extension portion 32D could also slightly tilt downward. The hook portion 34D is bent or curved downward and inward from the extension portion 32D, and is adapted to snap-fit the outer lip 142D of the front wall 14D of the casing 10D. The holding sheet 40D is adapted to push against an inner surface of the connecting plate 12D of the casing 10D. In more details, the holding sheet 40D is connected to the supporting plate 22D. In the current embodiment, an angle a included between an extension line of the holding sheet 40D and an imaginary line vertical to the supporting plate 22D is greater than 0 degree and less than or equal to 45 degrees. In other words, if a direction passing through the front end and the rear end of the supporting plate 22D is defined as a first direction D1, and another direction orthogonal to the first direction D1 is defined as a second direction D2, the holding sheet 40C has a first portion and a second portion other than the first portion, wherein the second portion has an offset relative to the first portion in the second direction D2. In the current embodiment, an extension plain of a top surface of the supporting plate 22B is defined as a horizontal plain, wherein the second direction D2 is parallel to the horizontal plain. In the current embodiment, an imaginary plain can be defined through the first direction D1 and the second direction D2, wherein the top surface of the supporting plate 22B is parallel to the imaginary plain. The first direction D1 and the second direction D2 are both orthogonal to a third direction D3, which is vertical to the imaginary plain. In more details, the number of the holding sheets 40D is two. Furthermore, the two holding sheets 40D are provided corresponding to each other in symmetry. Each of the holding sheets 40D includes a connecting portion 42D and a holding portion 44D, wherein the connecting portion 42D extends downward and bends inward from a lateral edge of the supporting plate 22D, and the holding portion 44D extends in a direction away from the supporting plate 22D from an end of the connecting portion 42D. As shown in FIG. 6C and FIG. 6D, each of the holding portion 44D has an offset relative to the corresponding connecting portion 42D in the second direction D2.

In addition, in the current embodiment, each of the holding portions 44D respectively has a holding end 43D at an end thereof away from the corresponding connecting portion 42D, wherein each of the holding ends 43D is adapted to abut against the inner surface of the connecting plate 12D, and a distance between the holding ends 43D is greater than a distance between the ends of the connecting portions 42D which are respectively connected to the corresponding holding portions 44D. In other words, in the current embodiment, a distance between the holding portions 44D gradually increases from the parts connected to the connecting portions 42D in a direction away from the supporting plate 22D. Whereby, the holding end 43D of each of the holding portion 44D has an offset L relative to the corresponding connecting portion 42D in the second direction D2. When the holding ends 43D of the holding sheets 40D abut against the connecting plate 12D of the casing 10D, the aforementioned designs (i.e., the connecting portions 42D extend outward and inward, and the holding portions 44D are respectively connected to the connecting portions 42D, extending downward and outward) would help to offset the a relative movement possibly created between the casing 10A and each of the brackets 20D due to a force somehow occurred in the longitudinal direction of the casing 10D (i.e., the second direction D2 of the holding sheet 40D), whereby to prevent the casing 10D and the brackets 20D from being slid or moved relative to each other in the longitudinal direction of the casing 10D. In more details, when the casing 10D and the brackets 20D are about to be moved relative to each other due to the force, the holding ends 43D of the holding sheets 40D would abut against the inner surface of the connecting plate 12D of the casing 10D, which would be capable of resisting against the connecting plate 12D of the casing 10D, and offsetting and counterbalancing the force thereby to prevent the relative movement. The holding ends 43D would firmly abut against the connecting plate 16D of the casing 10D, whereby to create a strong reverse resistance to the inner surface of the connecting plate 16D of the casing 10D. As a result, the casing 10D and the brackets 20D could be prevented from being moved relative to each other in the longitudinal direction of the casing 10D. It is also worth mentioning that, in other embodiments, the connecting portions 42D could be also designed to extend downward and outward, and the holding ends 43D connected to the connecting portions 42D could be designed to extend downward and inward. Such designs could also provide a reverse resistance comparable to that provided by the aforementioned structures. Therefore, the structures of the current embodiment are not limitations of the present invention.

The rear plate 24D extends from the rear end of the supporting plate 22D, wherein a second snap-fit portion 50D is provided at a bottom end of the rear plate 24D. The second snap-fit portion 50D is adapted to snap-fit the bottom of the rear wall 16D of the casing 10D. In the current embodiment, a wing 26D extending forward is respectively provided on each of two sides of the rear plate 24D, wherein the wings 26D are adapted to abut against the outer surface of the rear wall 16D of the casing 10D. In the current embodiment, the second snap-fit portion 50D extends toward the first snap-fit portion 30D from the bottom end of the rear plate 24D. Furthermore, the second snap-fit portion 50D includes an engaging plate 52D extending downward and forward from the bottom end of rear plate 24D. In addition, a supporting portion 54D is disposed on the engaging plate 52D. The supporting portion 54D includes a base portion 542D, which is connected to the engaging plate 52D and adapted to uphold the bottom end of the rear wall 16D. In the current embodiment, the supporting portion 54D is formed by extending forward from the engaging plate 52D and being bent inward. However, the method of forming the supporting portion 54D is not a limitation of the present invention. The supporting portion 54D of another embodiment can be also formed by being folded backward after being bent inward. The supporting portion 54D is adapted to snap-fit the second connecting portion 160D at the bottom end of the rear wall 16D. The supporting portion 54D has the advantage of providing superior strength to firmly hold the casing 10D, for the supporting portion 54D is formed by folding the engaging plate 52D.

During installation, the brackets 20D could be fixed at predetermined positions first, and then the casing 10D and the brackets 20D could be engaged together. In more details, the casing 10D could be tilted slightly forward to make the second connecting portion 160D of the rear wall 16A of the casing 10D abut against the supporting portion 54D of the second snap-fit portion 50D of each of the brackets 20D. Whereby, the brackets 20D could be effectively utilized to bear the weight of the casing 10D. After that, the casing 10D could be rotated and pushed backward with the second snap-fit portion 50D used as a fulcrum. In this way, the rear wall 16D of the casing 10D could be pressed against the rear plate 24D of each of the brackets 20D, and the outer surface of the rear wall 16D would abut against the wings 26D. Furthermore, the first connecting portion 140D of the casing 10D could be pushed into the first snap-fit portion 30D of each of the brackets 20D. As a result, for each of the brackets 20A, the first snap-fit portion 30D thereof would snap-fit the outer side of the first connecting portion 140D, and the holding sheets 40D thereof would push against the connecting plate 12D of the casing 10D. With the designs of the first snap-fit portion 30D, the second snap-fit portion 50D, and the holding sheets 40D of bracket 20D, the casing 10D would be abutted against in three directions to be firmly engaged. Therefore, the casing 10D and the brackets 20D would be unlikely to have relative sliding movement after being assembled.

It is worth mentioning that, the structures of the casings described in the aforementioned embodiments are not limitations of the present invention. In other embodiments, the structure of a casing could be different. In addition, the structures of the holding sheets described in the aforementioned embodiments are not limitations of the present invention, either. In other embodiments, the structure of a holding sheet could have different designs. For example, in another embodiment, the connecting portion could extend downward from a bottom edge of the supporting plate instead of extending downward from the lateral edge of the supporting plate. In addition, the connecting portion is not limited to be vertical to the supporting plate. In another embodiment, the connecting portion and the holding portion could be designed to extend downward and forward from the supporting plate. In addition, the number of the holding sheet and where the holding sheet abuts are not limited as mentioned in the above embodiments. For example, in another embodiment, the holding sheet could abut against the casing per se, or any surface defined on the casing. In another embodiment, there could be only one single holding sheet provided on the supporting plate to push against any surface of the front wall or the rear wall of the casing; alternatively, the holding sheet could coordinate with the first snap-fit portion or the second snap-fit portion to abut against both the inner and the outer surfaces of the front wall or the real wall of the casing at the same time.

It is worth mentioning that, the types of window covering compatible with the bracket and the assembly of the casing and the bracket disclosed in the present invention include, but not limited to, window blinds, Roman shades, roller shades, pleated blinds, cellular shades, drapery panels, sheer shades, double roller blinds (i.e., zebra blinds), etc. In addition, the window coverings include, but not limited to, vertical and horizontal types.

It must be pointed out that the embodiments described above are only some preferred embodiments of the present invention. All equivalent structures which employ the concepts disclosed in this specification and the appended claims should fall within the scope of the present invention.

What is claimed is:

1. A bracket for a window covering, comprising:
a frame, wherein a first snap-fit portion and a second snap-fit portion are respectively provided at two ends of the frame; the frame at least comprises a supporting plate; the first snap-fit portion is located at a front end of the supporting plate; a direction passing through the front end and a rear end of the supporting plate is defined as a first direction; another direction orthogonal to the first direction is defined as a second direction; and
a holding sheet, which is connected to the frame, wherein the holding sheet sequentially has a connecting portion, and a holding portion attached to the connecting portion;
wherein the holding portion has an offset relative to the connecting portion in the second direction.

2. The bracket of claim 1, wherein the second snap-fit portion is located at the rear end of the supporting plate; the connecting portion extends from the supporting plate located between the first snap-fit portion and the second snap-fit portion; the holding portion extends from the connecting portion toward the first snap-fit portion, toward the second snap-fit portion, or in a direction away from the supporting plate.

3. The bracket of claim 1, wherein the holding portion and the supporting plate are substantially parallel to each other.

4. The bracket of claim 1, wherein the connecting portion and the supporting plate are connected to each other; the holding portion extends from the connecting portion in a direction toward the first snap-fit portion, toward the second snap-fit portion, or in a direction away from the supporting plate.

5. The bracket of claim 1, wherein the frame further comprises a rear plate; the first snap-fit portion is formed at an end of the supporting plate, while the rear plate extends from another end of the supporting plate; the second snap-fit portion is provided at a bottom end of the rear plate.

6. The bracket of claim 5, wherein the holding sheet extends from the rear plate toward the first snap-fit portion.

7. The bracket of claim 5, wherein a wing extending toward the first snap-fit portion is provided on at least one side of the rear plate; the holding sheet extends from the wing toward the first snap-fit portion.

8. The bracket of claim 5, wherein the second snap-fit portion extends from the bottom end of the rear plate toward the first snap-fit portion; the second snap-fit portion includes a supporting portion bent forward and slightly upward from an end thereof.

9. The bracket of claim 5, wherein the second snap-fit portion has an upper horizontal segment, a lower horizontal segment, and at least one vertical segment; the upper horizontal segment, the lower horizontal segment, and the at least one vertical segments together define an opening; the lower horizontal segment is located closer to a rear side than the upper horizontal segment is.

10. An assembly for a window covering, comprising;
a casing having a connecting plate, a front wall, and a rear wall opposite to the front wall, wherein two sides of the connecting plate are respectively connected to the front wall and the rear wall; the front wall is provided with a first connecting portion; the rear wall is provided with a second connecting portion; a direction passing through the front wall and the rear wall is defined as a transverse direction of the casing, and the casing further has a longitudinal direction orthogonal to the transverse direction; and
a bracket comprising a frame and a holding sheet, wherein a first snap-fit portion and a second snap-fit portion are respectively provided at two ends of the frame; the frame at least comprises a supporting plate; the first snap-fit portion is located at a from end of the supporting plate, and is adapted to snap-fit the first connecting portion; the second snap-fit portion is adapted to snap-fit the second connecting portion; the holding sheet is connected to the frame, wherein the holding sheet sequentially has a connecting portion and a holding portion attached to the connecting portion;
wherein, the holding portion has an offset relative to the connecting portion in the second direction.

11. The assembly of claim 10, wherein the frame comprises a plate, and the first snap-fit portion and the second snap-fit portion are respectively formed at two opposite sides of the plate: the connecting portion extends from the plate, located between the first snap-fit portion and the second snap-fit portion; the holding portion extends from the connecting, portion toward the first snap-fit portion or the second snap-fit portion; the holding portion and the frame are substantially parallel to each other.

12. The assembly of claim 10, wherein the frame comprises a supporting plate and a rear plate; the first snap-fit portion is formed at an end of the supporting plate, while the rear plate extends from another end of the supporting plate; the second snap-fit portion is provided at a bottom end of the rear plate.

13. The assembly of claim 12, wherein the holding sheet extends from the supporting plate; the holding portion extends from the connecting portion toward the first snap-fit portion, toward the second snap-fit portion, or in a direction away from the supporting plate, wherein the holding portion is adapted to push against the casing.

14. The assembly of claim 12, wherein the holding sheet extends from the rear plate toward the first snap-fit portion.

15. The assembly of claim 12, wherein a wing extending toward the first snap-fit portion is provided on at least one side of the rear plate, and is adapted to abut against the rear wall of the casing; the holding sheet extends from the wing toward the first snap-fit portion.

16. The assembly of claim 12, wherein the second snap-fit portion extends from the bottom end of the rear plate toward the first snap-fit portion; the second snap-fit portion includes a supporting portion being bent forward and slightly upward from an end thereof, wherein the second snap-fit portion is adapted to snap-fit the second connecting portion.

17. The assembly of claim 10, wherein the first connecting portion has a bulging surface on an inner side thereof, the holding sheet is adapted to push against the bulging surface.

18. The assembly of claim 10, wherein the second snap-fit portion has an opening at an end thereof, wherein the opening is close to the second connecting portion.

19. The assembly of claim 18, wherein the second snap-fit portion has an upper horizontal segment, a lower horizontal segment, and at least one vertical segments connecting the upper and lower horizontal segments; the upper horizontal segment, the lower horizontal segment, and the at least one vertical segments together define the opening; the lower horizontal segment is located closer to a rear side than the upper horizontal segment is.
